(19) United States
(12) Patent Application Publication
(10) Pub. No.: US 2020/0293996 A1
(43) Pub. Date: Sep. 17, 2020

(54) COMPUTERIZED SYSTEMS AND METHODS FOR IMPROVED MOBILE WORKER TRACKING

(71) Applicant: Coupang, Corp., Seoul (KR)

(72) Inventors: Xiaofeng WU, Shanghai (CN); Yanchao LI, Shanghai (CN); Meng Chai LEE, Seoul (KR); Yul Hee LEE, Seoul (KR); Young Shin KANG, Seoul (KR); Han WEI, Shanghai (CN)

(73) Assignee: Coupang, Corp., Seoul (KR)

(21) Appl. No.: 16/355,460

(22) Filed: Mar. 15, 2019

(51) Int. Cl. G06Q 10/10; H04W 4/029; H04L 9/32; G06Q 10/08

(52) U.S. Cl. CPC G06Q 10/1091; G06Q 10/0833; H04L 9/3213; H04W 4/029

(57) ABSTRACT

Systems and methods for computerized time tracking are disclosed. In one aspect, a computer-implemented device is disclosed. The device comprises a memory storing instructions, a network device, a display device, and at least one processor configured to execute the instructions. The instructions direct the processor to determine a location of the device based on one or more network signals; based on the determined location, display a first user interface element that, when selected, records a start time associated with a user identifier; receive a selection of the first user interface element; after receiving a selection of the first user interface element, display a second user interface element that, when selected, records an end time associated with the user identifier; receive a selection of the second user interface element; and send at least one of the start time or the end time to a remote server via the network device.

### TECHNICAL FIELD

The present disclosure generally relates to computerized systems and methods for tracking the time worked by users. In particular, embodiments of the present disclosure relate to inventive and unconventional systems relate to logging time in and out for users, including an automated system of reminders and limits.

### BACKGROUND

The present disclosure relates to computerized systems and methods for tracking time worked by users. These systems enable employers to track the number of hours their employees work, track the productivity of employees, and ensure that employees do not work beyond their allotted time to help comply with employment laws.

Prior art systems require employees to log in and log out from a centralized location. For example, employers used to require employees to “punch-in” when they arrived at work, and thus began tolling the employee's time they worked. This system used a punch card that the employee inserted into a machine. The machine punched the card to mark the time the employee started working. When the employee stopped working, the employee then inserted the card again and the machine marked the time the employee stopped working. This system is limited by the number of punch machines the employer provides, often creating lines of employees waiting to punch in and out.

As technology advanced, the punch card system was replaced with electronic systems. For example, electronic time tracking systems used a computer terminal to allow a user to log in and log out, corresponding with a punch-in and punch-out. Similar to the punch card system, such systems are inconvenient—they are limited by the number of computer terminals, can result in slow processing of time information while employees wait to log in and log out, and can become a point of failure for an entire department or building of workers if the system goes down. In addition to causing technical problems, these backups can slow down internal and external processes and hurt worker productivity.

Therefore, there is a need for improved methods and systems for allowing employees to log in and log out of a system to track the hours the employees work. The system disclosed herein allows employees to use mobile devices, such as mobile phones, to log in and log out, eliminating the back up and delay of the old systems.

### SUMMARY

One aspect of the present disclosure is directed to a computer-implemented device for tracking a user's time, the device comprises a memory storing instructions, a network device, a display device, and at least one processor configured to execute instructions. Those instructions include determining a location of the device based on one or more network signals from the network device; based on the determined location, displaying on the display device a first user interface element that, when selected, records a start time associated with a user identifier; receiving, from the display device, a selection of the first user interface element; after receiving a selection of the first user interface element, displaying on the display device a second user interface element that, when selected, records an end time associated with a user identifier; and sending at least one of the first time or the end time to a remote server via the network device.

In another embodiment, displaying the first user interface element is based on determining that the current time is within an accepted time. In another embodiment, the accepted time is based on at least one of a vacation schedule, a shift schedule, or a needed capacity.

In another embodiment, the instructions further cause the at least one processor to receive, from a remote server, an amount of time worked by the user during a first time frame; determine whether the amount of time worked is greater than a maximum amount of time for the first time frame; and based on the determination, prevent the display of the first user interface element. In another embodiment, the instructions further cause the at least one processor to display a warning when the amount of time worked within the first time frame exceeds a threshold amount of time that is smaller than the maximum amount of time. In another embodiment, the instructions further cause the at least one processor to display a warning when the amount of time worked within the first time frame exceeds the maximum amount of time within the first time frame. In another embodiment, the instructions further cause the at least one processor to display a warning when the amount of time worked within the first time frame exceeds the maximum amount of time within the first time frame. In another embodiment, the instructions further cause the at least one processor to record the end time associated with the user identifier based on determining that the amount of time worked within the time frame exceeds the maximum amount of time within the time frame. In another embodiment, the instructions further cause the at least one processor to send, via the network device, a query to the remote server to determine activity associated with the user identifier; receive, via the network device, activity information from the remote server; based on the activity information, record the end time associated with the user identifier. In another embodiment, the instructions further cause the at least one processor to, responsive to the selection of the first user interface element, send a token to the remote server; send, via the network device, a query to the remote server to determine whether the token has been used within a second time frame; receive, via the network device, activity information from the remote server indicating whether the token has been used within the second time frame; and based on the activity information, record the end time associated with the user identifier. In another embodiment, the instructions further cause the at least one processor to send, via the network device, a query to the remote server when the number of hours worked within a time frame exceeds a threshold number of hours that is smaller than the maximum number of hours.

In another embodiment, the instructions further cause the at least one processor to record the end time associated with the user identifier based on a determination that the device is outside of an accepted location. In another embodiment, the location is determined based on a proximity of a wireless network.

In another embodiment, the device sends the data collected to the central system based on scheduled updates or in real time.

In another embodiment, the first user interface element includes an input field for information regarding the user's job during the logged in time. In another embodiment, the instructions further cause the at least one processor to display, on the display device, at least one category of job role; receive, on the display device, an input selecting at least one of the categories of job roles; display, on the display device, at least one question based on the category of job role selected; and receive, on the display device, at least one answer to the at least one question.

Another aspect of the present disclosure is directed to a method for tracking a user's time, comprising the steps of determining a location of a computer-implemented device based on one or more network signals from a network device of the device; displaying on a display device of the computer-implemented device, based on the determined location, a first user interface element that, when selected, records a start time associated with a user identifier in a memory device of the computer implemented device; receiving, on the display device a selection of the first user interface element; displaying, after receiving a selection of the user interface element on the display device, a second user interface element that, when selected, records an end time associated with a user identifier in the memory device of the computer implemented device; receiving, on the display device, a selection of the second user interface element; and sending at least one of the start time or the end time to a remote server via the network device.

In another embodiment, displaying the first user interface element is based on determining that the current time is within an accepted time.

In another embodiment, the method further includes the steps of receiving, from a remote server, an amount of time worked by the end user during a first time frame; determining whether the amount of time worked is greater than a maximum amount of time for the first time frame; and based on the determination, preventing the display of the first user interface element. In another embodiment, the method may further include the step of displaying a warning when the amount of time worked within the first time frame exceeds the maximum amount of time within the first time frame.

Yet another aspect of the present disclosure is directed to a system for tracking a user's time comprising a mobile device and a central server. The mobile device comprises a network device, a display device, at least one processor and at least one memory storing instructions. The instructions include determining, using the network device, a location of the device based on one or more network signals; based on the determined location, displaying on the display device, a first user interface element that, when selected on the display device, records a time associated with a start time for a user; receiving, on the display device, a selection of the first user interface element; sending data contained within the start input to a central system after receiving the input selecting the first user interface element; receiving analytical data from the central system about the user; after receiving a selection of the first user interface element, displaying on the display device, a second user interface element that, when selected on the display device, records a time associated with an end time for the user; receiving, on the display device, a selection of the second user interface element; and sending data contained within the end input to a central system after receiving the input selecting the second user interface element. The central server comprises a network device, a display device, a database, and at least one processor and at least one memory device storing instructions. The instructions include receiving, via the network device, time data including at least one of a start time or an end time; storing the received time data in the database in association with a user identifier; receiving a request from the mobile device for at least one of past start time or past end time information; and sending at least one of the past start time or end time information to the mobile device.

Yet another aspect of the present disclosure is directed to a system for tracking a user's time comprising a mobile device and a management system communicating with the mobile device to send and receive the data from the mobile device. The mobile device comprises a network device, a display device, and at least one processor and at least one memory storing instructions. The instructions including displaying, on the display device, a job option for selecting a job role; based on the job role selected, using the network device to request data from a central system associated with the job role and a user; determining a location of the device based on one or more network signals from the network device; based on the determined location, display, on the display device, a first user interface element that, when selected on the display device, records a time associated with a start time for a user; receiving, from the display device, a selection of the first user interface element; sending data contained within the start input to a central system after receiving the input selecting the first user interface element; receiving analytical data from the central system about the user; after receiving a selection of the first user interface element, display on the display device, a second user interface element that, when selected on the display device, records a time associated with an end time for the user; receiving, from the display device, a selection of the second user interface element; and sending data contained within the end input to a central system after receiving the input selecting the second user interface element.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3A is a flowchart of an exemplary log in and log out process in accordance with the disclosed embodiments.

FIG. 3B is a diagram of an exemplary application selection screen in accordance with the disclosed embodiments.

FIG. 3C is a diagram of an exemplary log in screen in accordance with the disclosed embodiments.

FIG. 3D depicts an exemplary use of a start button in accordance with the disclosed embodiments.

FIG. 3E depicts an exemplary use of an end button in accordance with the disclosed embodiments.

FIG. 4 is a flowchart of an exemplary log in and log out process in accordance with the disclosed embodiments.

FIG. 5A is a diagram of an exemplary application selection screen in accordance with the disclosed embodiments.

FIG. 5B is a diagram of an exemplary home screen in accordance with the disclosed embodiments.

FIG. 5C is a diagram of an exemplary data input screen for entering a vacation request in accordance with the disclosed embodiments.

FIG. 5D is a diagram of an exemplary vacation request status screen in accordance with the disclosed embodiments.

FIG. 6 is a diagram of an exemplary manager's portal interface in accordance with the disclosed embodiments.

FIG. 7 is a database table of an exemplary database for the requirements of different types of vacations in accordance with the disclosed embodiments.

FIG. 8 is a block diagram of an exemplary computing device.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations, and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for allowing users to log in and out to track time worked, and providing alerts and other time controls to prevent users from working too many hours.

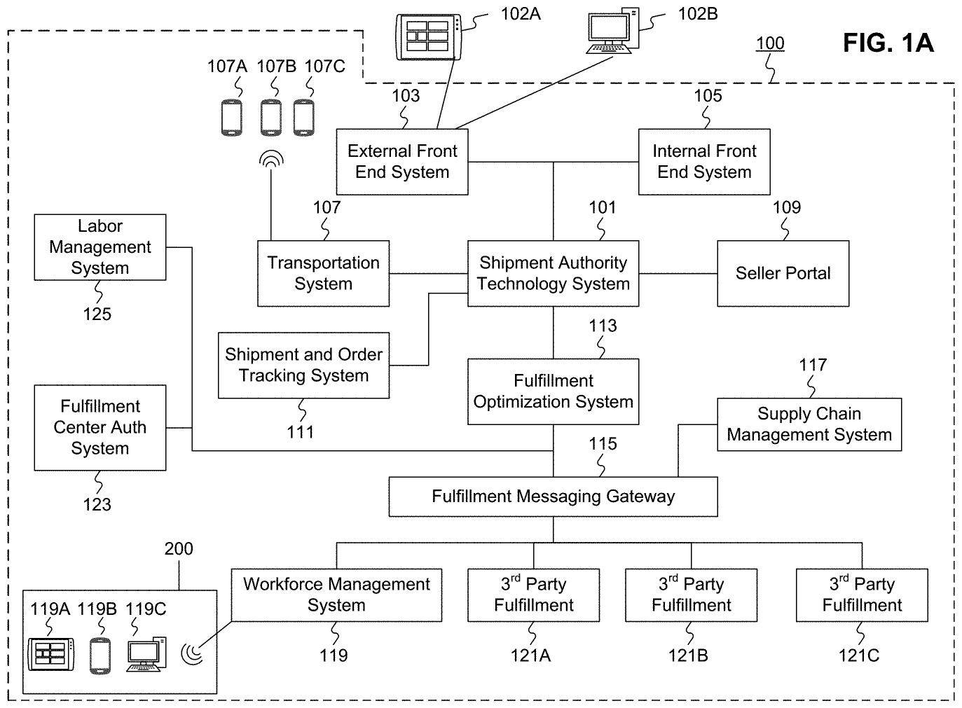

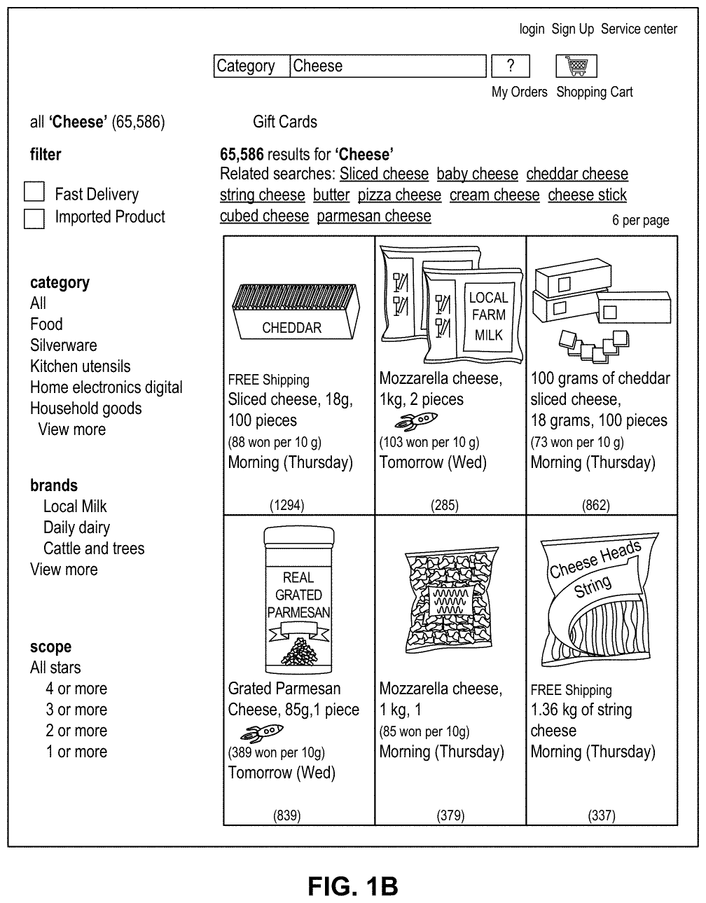

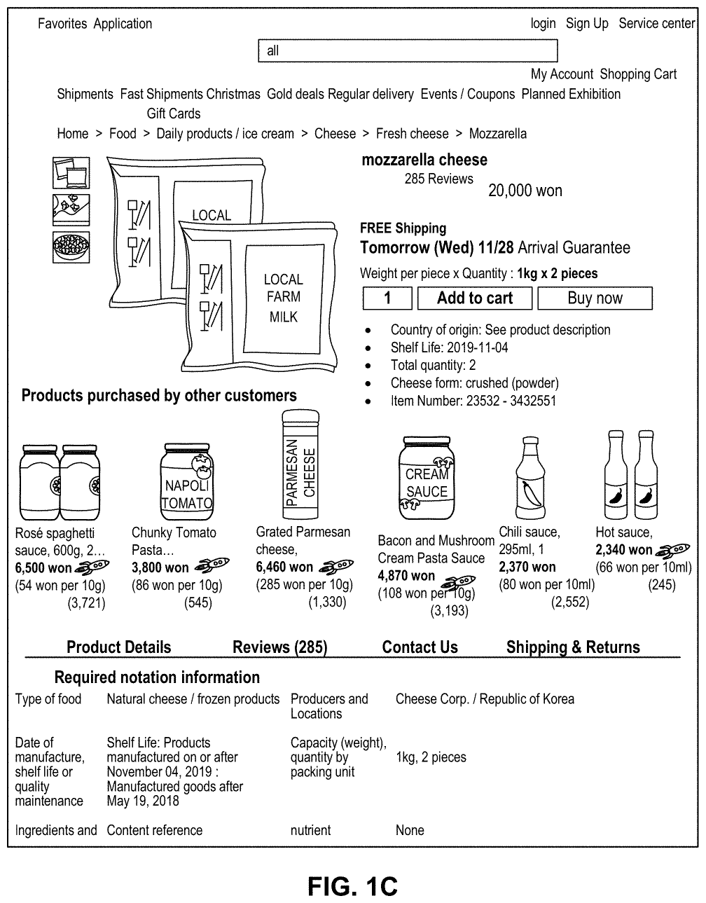

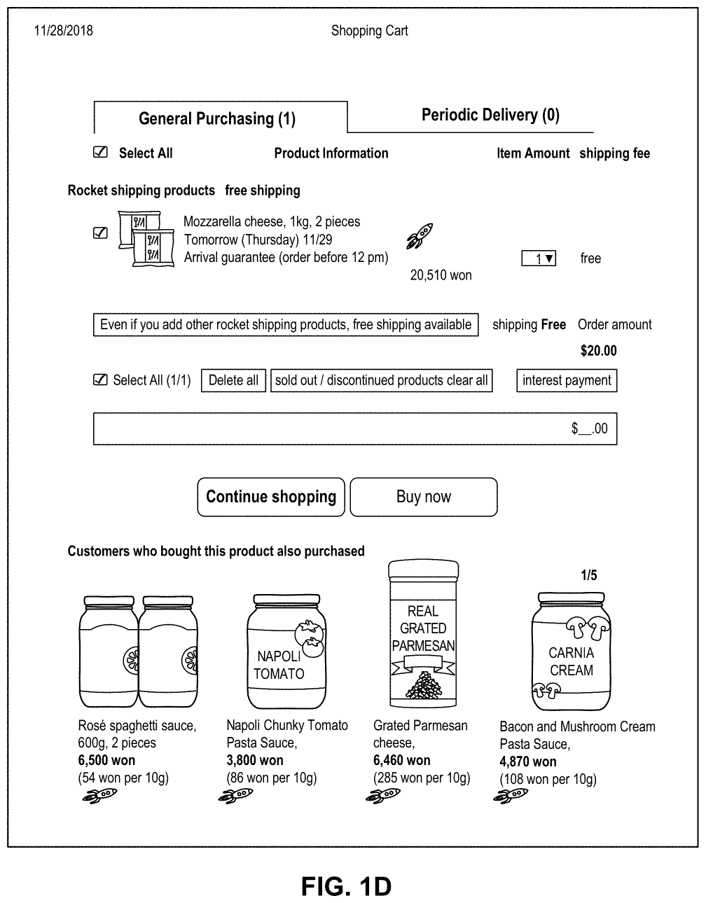

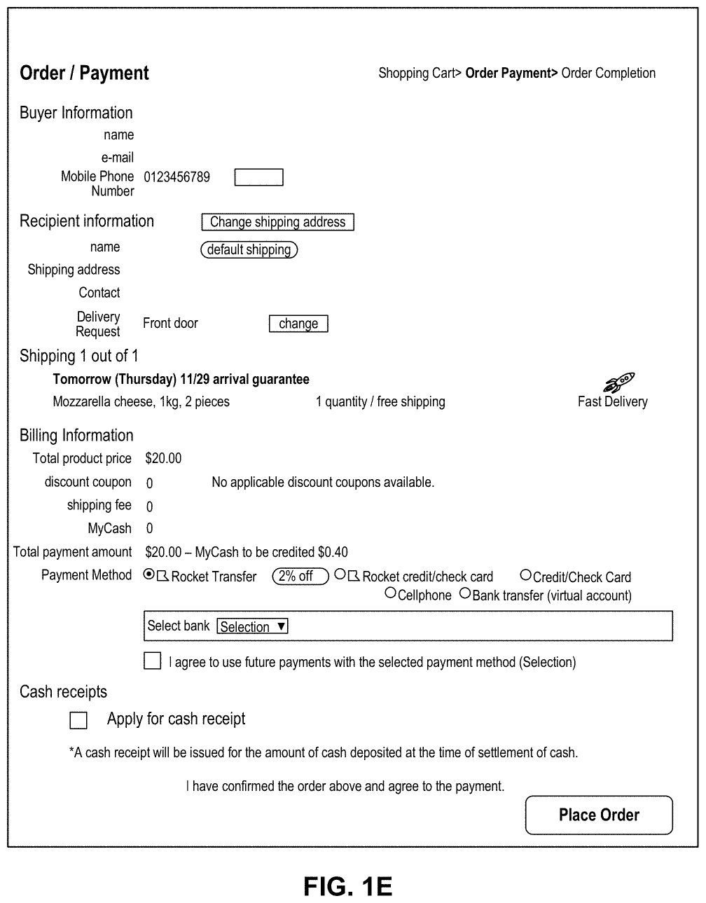

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, workforce management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from workforce management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfillment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfillment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the expected forecasted demand for a particular product.

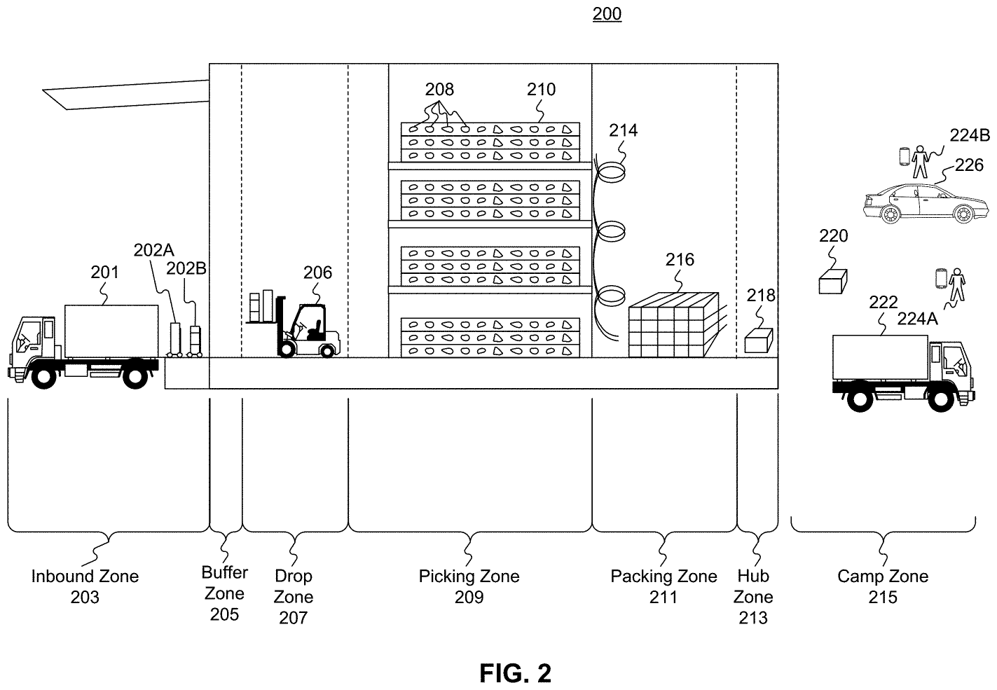

Workforce management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1196, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C. This activity information may be used to track a user's productivity.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more 3PL systems 121A-121C may be part of system 100, while in other embodiments, one or more of 3PL systems 121A-121C may be outside of system 100 (e.g., owned or operate by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicates an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

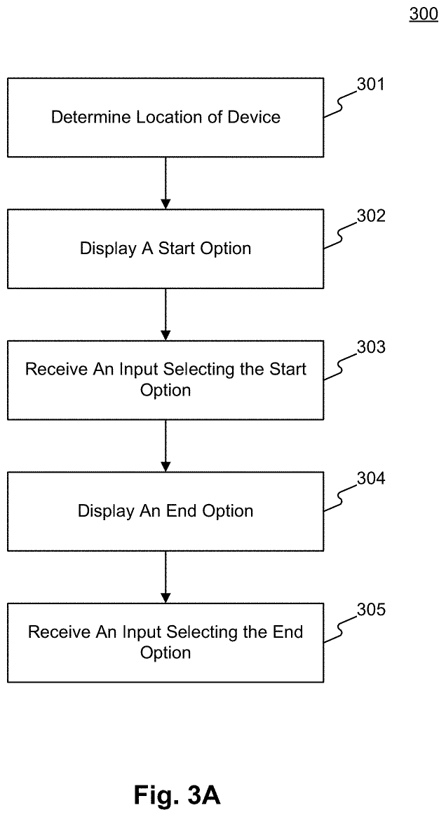

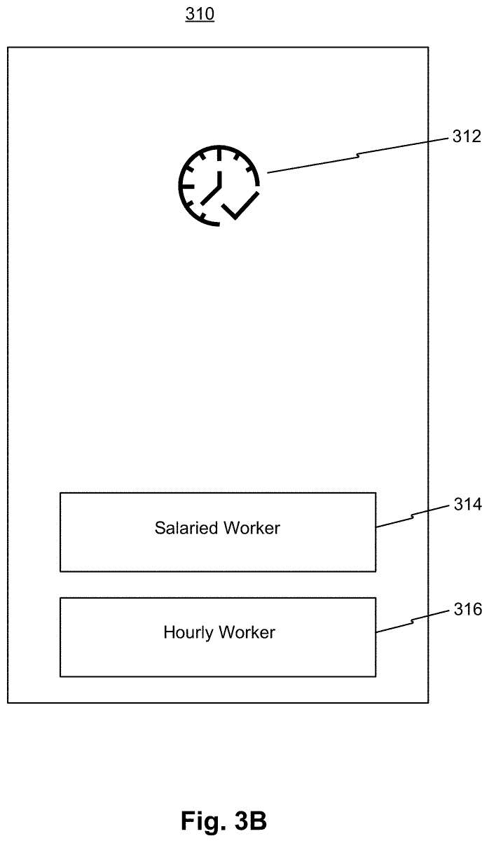

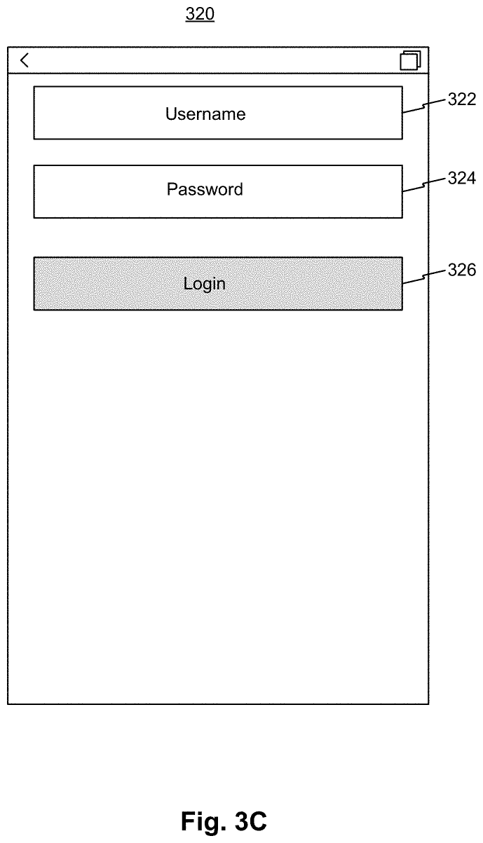

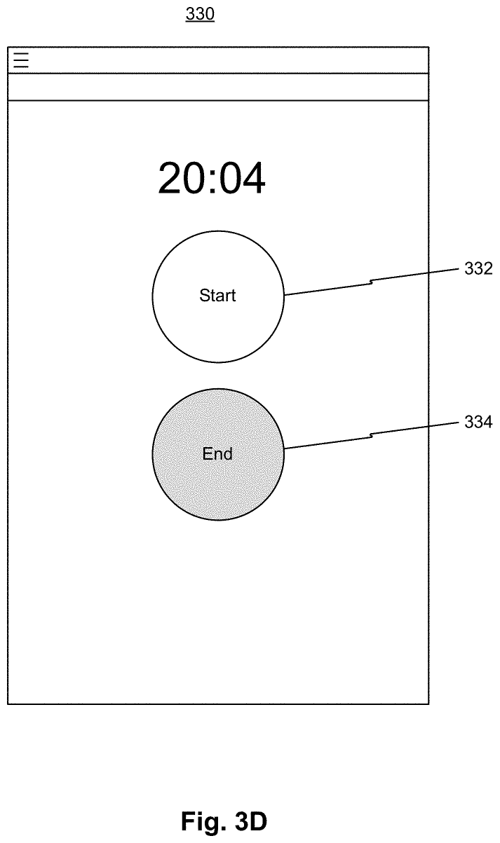

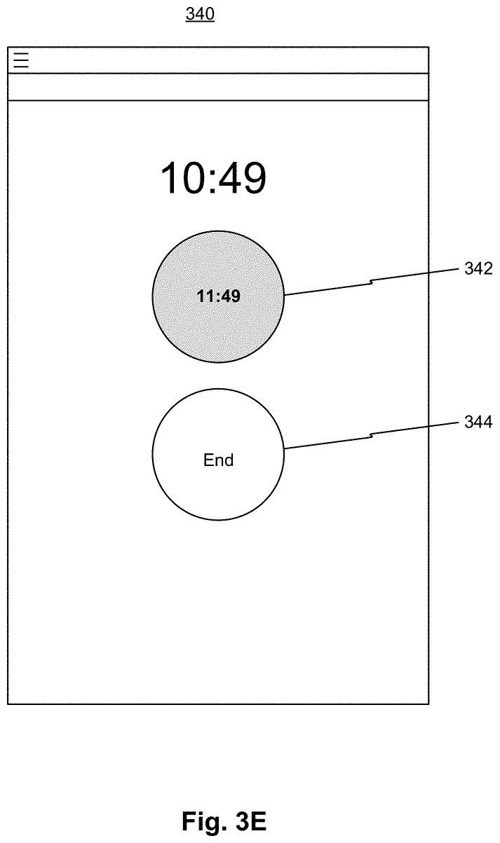

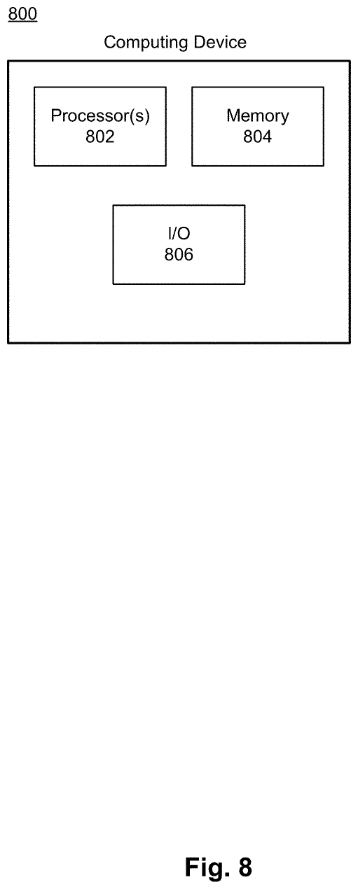

FIG. 3A is a flowchart illustrating steps of an exemplary log in and log out process 300 that may be performed by a processor in accordance with the disclosed embodiments. For example, process 300 may be performed entirely or in part on a computing device such as a smart phone or PDA (e.g., devices 119A-119C in FIG. 1). FIG. 8 described below, is an example of such a device that may perform the process using processor 802. While process 300 is described with respect to computing device 800, one of skill will understand that other devices may implement process 300. One of skill will further understand that the steps illustrated in FIG. 3A are exemplary and steps may be added, duplicated, modified, or deleted in some embodiments.

At step 301, processor 802 determines a location of the mobile devices 119A-119C. Processor 802 may utilize several forms of information available through the mobile device to determine the location of the mobile devices 119A-119C. For example, the location may be determined by the mobile devices 119A-119C connecting to a wireless network associated with a location, GPS data, or any other form of location data known in the art.

At step 302, processor 802 instructs computing device 800 to display a first user interface element that executes a start option that allows the user to indicate that the user is beginning work (e.g., on a display). In some embodiments, computing device 800 will only display the start option when it determines that computing device 800 is within an accepted location, such as the location of a warehouse, fulfillment center, office, or other place associated with an employer.

In another embodiment, the processor 802 will only instruct the computing device 800 to display the start option when the user accesses the processor at an accepted time to start working according to the user's work schedule. In some embodiments, a memory device of computing device 800 (e.g., memory 804) may store the user's work schedule, in other embodiments the WMS 119 and/or LMS 125 may store the user's work schedule, and in other embodiments, any other system within the system 100 may store the user's work schedule and synchronize the stored information with other systems in system 100. The user's work schedule may include the user's shift schedule, the employer's needed capacity for workers, the user's vacation schedule, or any other information that determines when the user is allowed to work. When the user's work schedule is stored in a system, such as WMS 119, the processor 802 may receive the user's schedule from the WMS 119. For example, processor 802 may query the WMS 119 to determine whether the user is allowed to work at that time, receive the user's full work schedule, or perform any other action that informs the processor 802 whether the user may start working.

In another embodiment, the computing device 800 may only display the start option if the user has not worked too many hours in a time frame. In this example, the computing device may either access the memory 804, WMS 119, or LMS 125 to receive the number of hours the user has worked. If the user has worked more than a maximum number of hours for a time frame, the computing device 800 will not display the start option. Alternatively, the computing device 800 may not display the start option if the user has worked more hours than any limit set by the employer. Another alternative allows the computing device 800 to receive a command from the WMS 119 or LMS 125 to not display the start option. This command from the WMS 119 or LMS 125 may be based on the WMS 119 performing the above analysis or any other reason set within the WMS 119 or LMS 125.

At step 303, the computing device 800 receives an input from the user indicating that the user selected the start option. In some embodiments, this input may contain the information that the user has started work at the time when the start option was selected. In other embodiments, the user may provide the input through a user interface. In other embodiments, the input may include additional data such as the jobs worked, tasks the user will perform, hours worked, anticipated number of hours, location, locations worked, productivity information, and any other information the employer may want to receive. Computing device 800 may record the time the user started work, for example, in a database or file on computing device 800.

In some embodiments, the computing device 800 may collect this data by asking questions before or after the user selects the start option. These questions may ask for yes/no answers, choices between options or categories, open entries, or any other type of question the employer wishes to ask. In other embodiments, the computing device 800 may collect this data from the user's work schedule if the data is contained therein. The computing device 800 may also ask a series of questions based on the answer(s) to or category selected in the previous question(s). The computing device 800 then receives the answer selected.

In some embodiments, the computing device 800 may also send the data collected to the WMS 119 and/or LMS 125. The computing device 800 may send this information after receiving the information in the input, based on scheduled updates, or in real time as the processor 802 receives information. The computing device 800 may send this as information stored in HTTP requests, as flags in HTTP requests, as part of a social networking message, or another protocol known in the art.

At step 304, the computing device 800 displays a second user interface element that executes an end option that allows the user to indicate that the user is ending work.

At step 305, the computing device 800 receives an input from the user that the user selected the end option. In some embodiments, this input may contain the information that the user has stopped work at the time when the end option was selected. In other embodiments, the input may include additional data such as the jobs worked, tasks the user performed, hours worked, anticipated number of hours, location, locations worked, productivity information, and any other information the employer may want to receive. Computing device 800 may record the time the user ended work, for example, in a database or file on computing device 800.

In some embodiments, the computing device 800 may collect this data by asking questions before or after the user selects the end option. The computing device 800 may ask these questions through a user interface, which allows the user to enter answers through radio buttons, buttons, voice interaction, alphanumeric input, or other methods known in the art. These questions may ask for yes/no answers, choices between options, open entries, or any other type of question the employer wishes to ask. In other embodiments, the computing device 800 may collect this data from the user's work schedule if the data is contained therein.

In some embodiments, the computing device 800 may also send the data collected (e.g., start time, end time) to the WMS 119 and/or LMS 125. The computing device 800 may send this information after receiving the information in the input, based on scheduled updates, or in real time as the processor receives information.

In some embodiments, the computing device 800 may also receive data from the WMS 119 or LMS 125. This data and information may include the number of hours a user has worked, the maximum number of hours a user can work, the user's accepted time, the user's accepted locations, a report compiling and analyzing data about the user, or other information and data.

In some embodiments, the computing device 800 may also execute instructions to automatically warn or log out a user if the computing device 800 detects certain conditions. For example, the user may be logged out if the user leaves an accepted location. Another example may be that the computing device 800 may issue a warning to the user if the number of hours the user has worked when the user exceeds a preset number of hours for a time frame. These warnings may be intended to prevent the user from working more than the maximum number of accepted hours. In some embodiments, the computing device 800 may issue the warning when a threshold number of hours that is less than the maximum number of hours is met. This warning informs the user that they are approaching the maximum number of hours. The computing device 800 may also or alternatively be programmed to issue the warning when the user reaches the maximum number of hours, informing the user to log out and stop working.

In another embodiment, the computing device 800 may automatically execute the end option and log out the user upon detecting that a user exceeds the maximum number of hours. The computing device 800 may also query the WMS 119 and/or LMS 125 for data or instructions on how to proceed.

In some embodiments, the computing device 800 may keep track of the hours worked by the hours worked by the user, for example by storing the information in memory 804. However, the WMS 119 or LMS 125 may also track the user's hours, and the computing device 800 may query the WMS 119 or LMS 125 to receive the number of hours worked, instructions to issue a warning as described, or instructions to execute the end option and log out the user.

In some embodiments, the computing device 800 may also query the WMS 119 or LMS 125 to determine whether the user has been active, i.e., whether the user is actually working. In some cases, users may forget to log out when they leave or otherwise not log out. This functionality allows the employer to ensure the user is actively working while the user is logged in. To accomplish this, the computing device 800 may query the WMS 119 or LMS 125. The WMS 119 or LMS 125 either contains the activity information necessary to make the determination or can in turn query other systems to receive activity information necessary to make the determination. As described earlier, activity information to determine whether a user is actively working may include whether the user has moved any items through the system, is logged into any part of the system 100, or any other activity information.

After receiving the activity information, the WMS 119 or LMS 125 may either analyze the data to determine whether the user is actively working or send the data to the computing device 800, where the computing device receives the activity information and analyzes the activity information to determine whether the user is actively working.

If the computing device, WMS 119, or LMS 125 determines that the user is not actively working, the processor 802 can be instructed to execute the end option and log out the user.

In some embodiments, the computing device 800 may use a token to determine whether the user has been active. When a user selects a start option, the computing device 800, WMS 119, or LMS 125 issues a token. Whenever the user uses any part of the system 100, that part of the system will use the token to authenticate the user. Tokens may identify a login session or user identity, and may include data in a variety of forms, including numbers, letters, or the like. In some embodiments, tokens may also be cryptographic. For example, if the user scans a package identifier and when moving a unit to a different location, the scanning device may use the token to access WMS 119 or LMS 125 to send the event data as discussed above. The computing device 800 can execute instructions to query the WMS 119 or LMS 125 for information indicating whether the token has been used within a time frame, for example two days. If the information indicates the token has not been used, then the computing device 800 executes the end option to log out the user.

FIGS. 3B-E illustrate an exemplary interface for a program executed by the computing device. The description of these figures serves to explain the functionality of the program. This program may be executed on any device accessible to the user, for example mobile devices 119A-119C. The program may be accessed as a webpage using a link, QR code, or web address, it may be a program downloaded to a memory device of the computing device, or any other form of accessing the program known in the art. While the descriptions of FIGS. 3A-D describe features within the interface, some features may be omitted and other features may be added based on the specific implementation for the program.

FIG. 3B illustrates an exemplary task-selection screen 310. In some embodiments, task-selection screen 310 may include one or more blocks 312, 314, and 316. A block in the interface may include drop down menus, buttons, radio buttons, alphanumeric inputs, or other UI features known in the art. Block 312 may be an option to choose a type of role or location. For example, block 312 may be used to select between working in an fulfillment center (FC), a warehouse, as a delivery worker, or other roles. The program may also include instructions to present specific features, options, or questions to the user based on the role selected. Blocks 314 and 316 may be options to choose between logging in as an hourly worker, a salaried worker, or other roles that the employer chooses to define.

FIG. 3C illustrates an exemplary log in screen 320. Block 322 may be an input field receiving the user's identification credentials. For example, the input field may receive a telephone number, a user identification number, a username, or other information known in the art for identifying users. Block 324 may be a block for receiving the user's authentication credentials. For example, the input field may receive a password, a personal identification number, or other information known in the art for authenticating users. Block 326 may be a submit, or “log in” option. In another embodiment, block 326 may also include other options such as password recovery, username recovery, or other options.

FIG. 3D illustrates an exemplary start option screen 330. When the user is able to log in, as described for process 300, the computing device 800 may display a start option for the user to log in. For example, screen 330 may display button 332 for the user to select. In some embodiments, screen 330 may also include button 334 showing the log out option. In this embodiment, screen 330 may indicate that the start button 332 is selectable while the end button 334 is not selectable. The screen may display both buttons but indicate to the user that the user may not select the start button 332, such as when the user is not in an accepted location. In some embodiments, the log in screen 330 may also include the current time and date. This time may be displayed within log in button 332 or anywhere else on the screen.

In some embodiments, log in screen 330 may indicate whether the buttons 332 and 334 are selectable using the colors of the buttons. For example, the button may be green when it is selectable, but the button may be gray when the button is not selectable. In other embodiments, the selectable button may be highlighted with a colored border, or any other indication known in the art.

FIG. 3E illustrates an exemplary end option screen 340. FIG. When the user is able to log out, as described for process 300, the computing device 800 may display an end option for the user to log out. For example, the screen may display button 342 that displays that the user previously logged in. In some embodiments, button 342 may include an amount of time (e.g., in hours and/or minutes) that the user has been logged in, or a time indicating when the user originally logged in.

In other embodiments, the screen may also include button 344 which enables the user to log out (or “punch out”). In this embodiment, the screen may indicate that the start button 342 is not selectable while the end button 344 is selectable. The screen may also display both buttons and indicate to the user that the user may not select the end button 342, such as because the user has not worked enough hours for the day.

In some embodiments, log out screen 340 may indicate whether the buttons 342 and 344 are selectable using the colors of the buttons. For example, the button may be green when it is selectable, but the button may be gray when the button is not selectable. In other embodiments, the selectable button may be highlighted with a colored border, or any other indication known in the art.

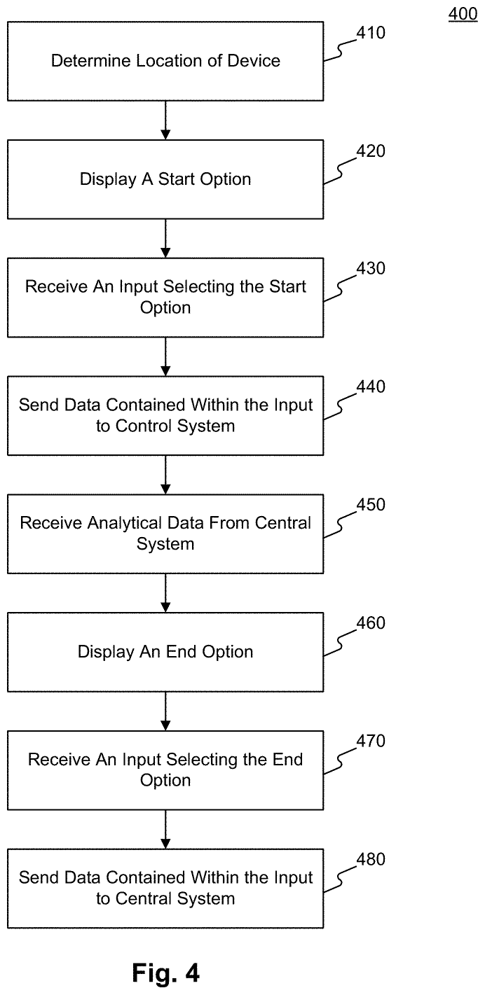

FIG. 4 is a flowchart illustrating steps of an exemplary log in and log out process 400 in accordance with the disclosed embodiments. Process 400 implements a system to log in and log out a user. In some embodiments, steps 410-430 may be implemented as described above with respect to steps 301 to 303, and 460-470 may be implemented as described above with respect to 340-350 of process 300. These corresponding steps are described within the description of process 300 and are not described here.

Process 400 differs, in part, from process 300 by steps 440-450, and 480. In step 440, computing device 800 may send the data contained within the input to the WMS 119 or LMS 125. The computing device may send this information after receiving the information in the input, based on scheduled updates, or in real time as the processor receives information.

In step 450, computing device 800 may receive analytical data from the WMS 119 or LMS 125. This analytical data can be information regarding how many hours the user has worked, whether the user has or is about to exceed the maximum number of hours allowed, whether the user has worked within a time frame, productivity information or any other analytical data discussed herein.

In step 480, computing device 800 may send data contained within the input with the end option to the WMS 119 and/or LMS 125. Similar to step 440, the computing device 800 may send this information after receiving the information in the input, based on scheduled updates, or in real time as the processor receives information. Such additional aspects of process 400 are not limiting on the process 300 above, but instead illustrate further capabilities of system 100.

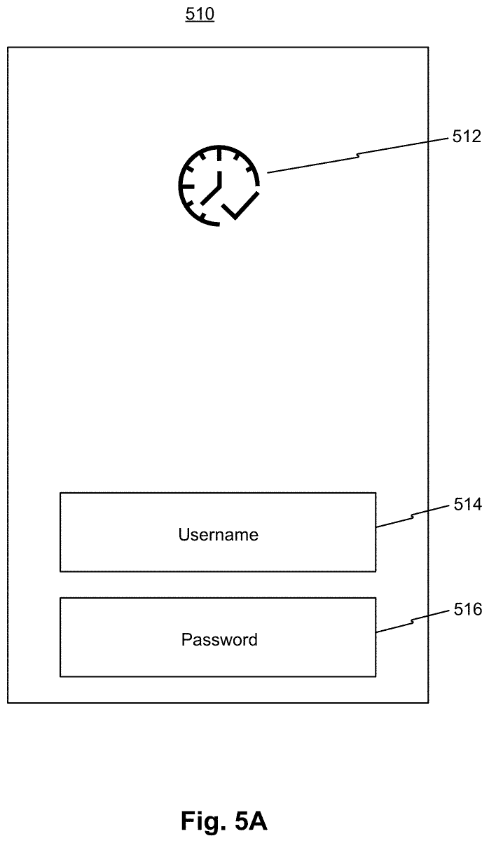

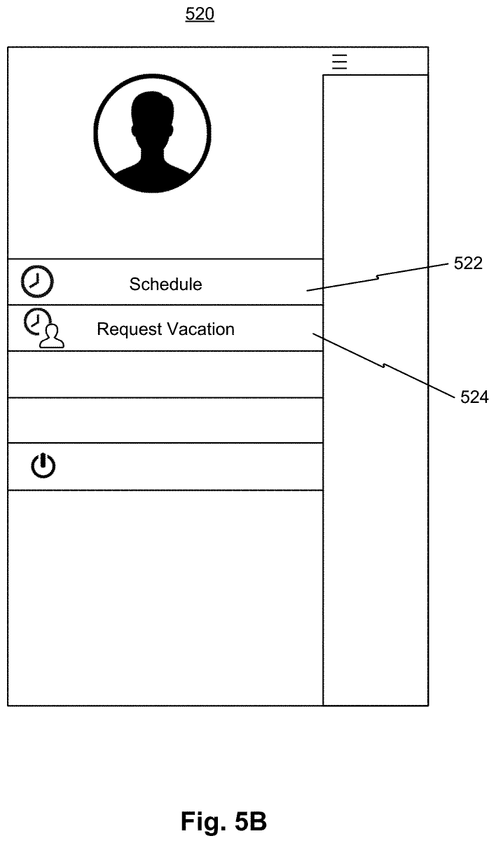

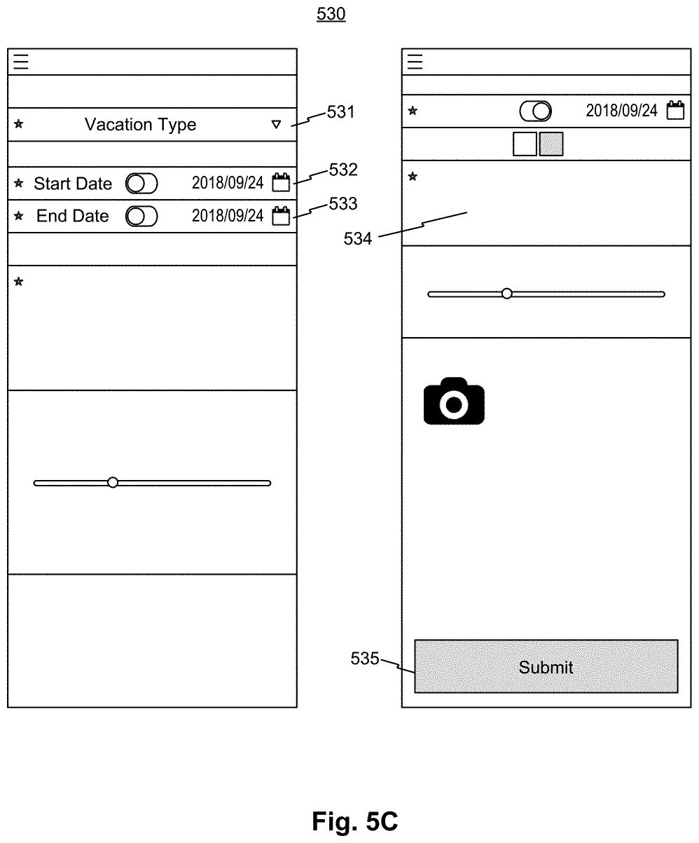

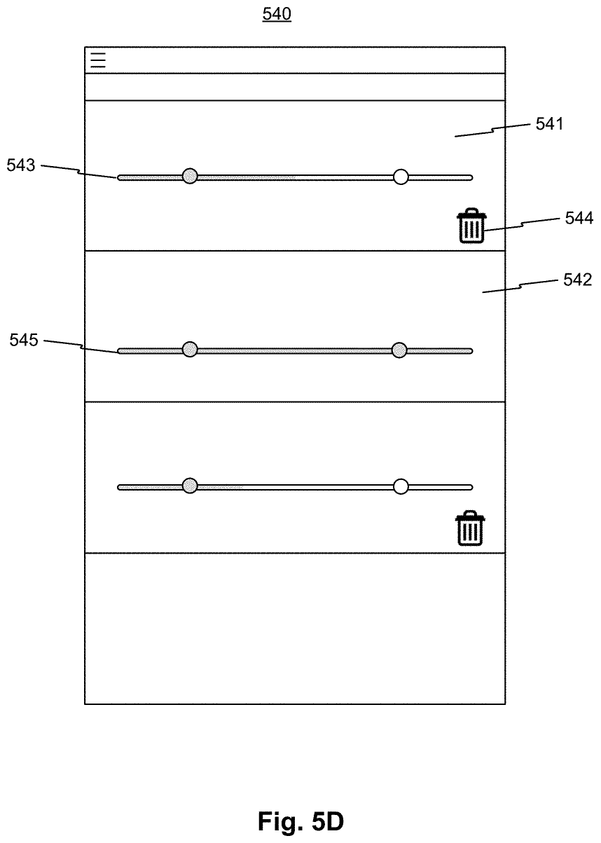

FIGS. 5A-E illustrate exemplary interfaces for a program executed by a computing device, such as mobile devices 119A-119C. The description of these figures serves to explain some functionality of the program. This program may be executed on any device accessible to the user. The program may be accessed as a webpage using a link, QR code, web address or the like. The program may also be downloaded to memory device 804. In other embodiments, other forms of accessing the program known in the art may be used. While the descriptions of FIGS. 5A-E describe features within the interface, some features may be omitted and other features may be added based on the specific implementation for the program.

FIG. 5A illustrates an exemplary log in screen 510. Block 512 enables the user to select the job role, job location, or other preliminary information that may be needed. A block in the interface may include drop down menus, buttons, radio buttons, alphanumeric inputs, or other UI features known in the art. In some embodiments, the user may select to work in a warehouse, a fulfillment center, or other role. The program may include instructions to present specific features, options, or questions to the user based on the role selected.

Block 514 may be an input field receiving the user's log in credentials. For example, the input field may receive a user identification number, username, password, personal identification number, or other information known in the art for authenticating users. Block 516 may then be a submit, or “log in” option, such as a button. In another embodiment, block 516 may also include other options such as password recovery, username recovery, or other options.

FIG. 5B illustrates an exemplary home screen 520 for the program. In some embodiments, block 522 may be a button to view the user's schedule or information, depict a user's schedule, show other information for the user, or the like. Button 524 may direct the computing device to initiate a vacation request.

FIG. 5C illustrates an exemplary screen 530 in a vacation request. FIG. 5C depicts two different sections of the same screen (e.g., a top portion and a bottom portion), which a user may have to scroll through the window to view. FIG. 5C may display a form for the user to input information for the vacation request, including block 531, which displays the type of vacation requested. Block 531 could be represented as a drop-down menu, a series of radio buttons, an alphanumeric input, or any other known form of information selection. FIG. 5C further includes block 532 for the user to enter a start date for the vacation request, block 533 for the user to enter an end date for the vacation request, block 534 for the user to enter a description of the vacation request, and button 535 to submit the vacation request.

In some embodiments, block 534 may include an alphanumeric entry for the user to enter a description of the vacation request, option of types of vacations the user may select, or other forms of input for the user to provide a description of the vacation request.

In other embodiments, block 534 may include an option to provide proof of the vacation. In this embodiment, some employers may require proof that a vacation was taken for a particular purpose, such as a doctor's visit or jury duty. When the type of vacation will have evidence beforehand, such as a summons for jury duty, the employer may require the user to upload that evidence to be included in the vacation request. Similarly, this information may not be available until a later time, such as a doctor's note after the doctor's appointment has occurred. The program may also provide users an option to submit this evidence at a later time. The user may input this evidence, for example, by taking a picture from within the program, or by uploading a file with the required proof included.

FIG. 5D illustrates an exemplary screen 540 for the program. This screen displays a user's vacation requests and may be accessed from the screen displayed in FIG. 5B or any other screen. On this screen, blocks 541 and 542 represent two different vacation requests. The screen 5D may contain as many blocks as there are vacation requests, including no blocks when there are no vacation requests. Block 542 shows an example vacation request. This request includes a progress bar 543 and a delete button 544.

In some embodiments, progress bar 543 may include a set of notes, and the nodes are colored in as their represented tasks are completed. In the present embodiment, progress bar 543 includes three nodes. The first node may represent a completed vacation request as discussed for FIG. 5C. The second node may represent a manager has approved the application. Additional nodes may be added as well. For example, as illustrated by progress bar 545, there may be a third node, which may represent a second manager's approval, that evidence has been uploaded, or other criteria to complete a vacation request. The evidence example may be used when a user has requested a vacation that requires evidence that is not attainable until after the vacation has been taken, such as a doctor's note certifying that the doctor's appointment was taken as discussed earlier.

Delete button 544 may allow a user to delete a vacation request. In some embodiments, this option may only be available until the vacation has been approved, but other embodiments may allow the user to delete the vacation request later, such as any time before the vacation actually occurs. Selecting delete button 544 may also cause the computing device to produce a confirmation message or screen for the user to confirm that they would like to delete the vacation request.

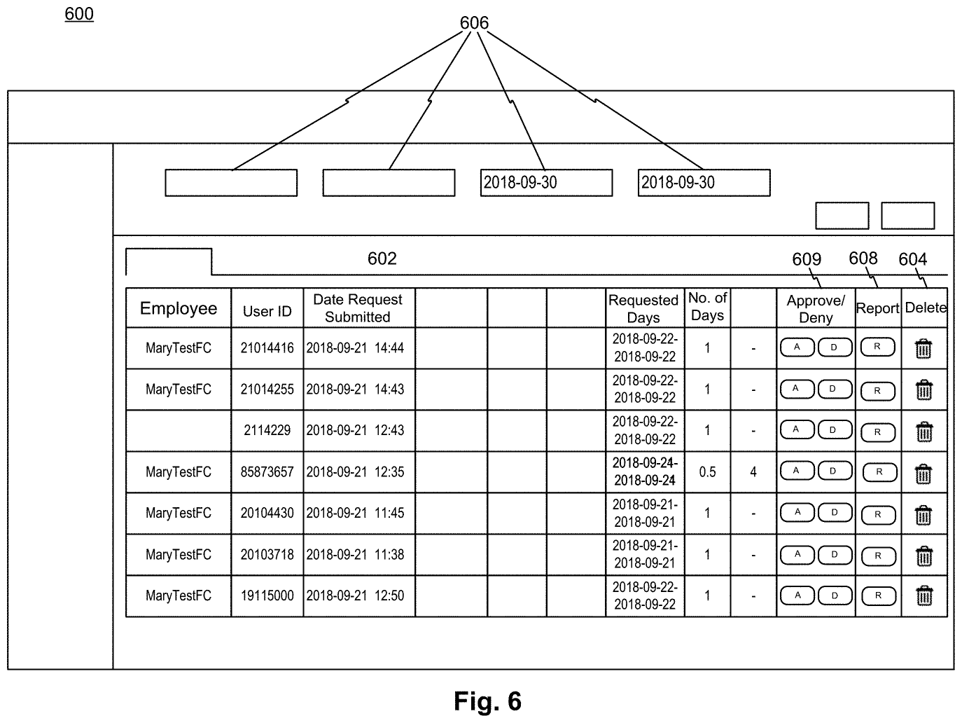

FIG. 6 illustrates a manager's portal 600 through which a manager may manage vacation and other scheduling requests. In some embodiments, the manager's portal 600 may be accessible through a device, such as one or more of mobile devices 119A-119C using the manager's log in credentials. Other embodiments may only allow the manger's portal 600 to be accessed through internal front end system 105.

Manager's portal 600 may include table 602 and search options 606. Table 602 represents a table of vacation requests where each row is a vacation request and each column is information or options related to the vacation request. Exemplary information may include the identification information for the user that submitted their vacation request, such as the user's name, user ID, employment type, group, and other information the manager may want to see.

In some embodiments, table 602 may also include a column with delete button 604 available for each request. Delete button 604 may be displayed only until the vacation request is approved, or after the vacation request is approved. Selecting delete button 604 may also cause the computing device to display a confirmation option or confirmation screen.

In some embodiments, table 602 may also include a report button 608 for each vacation request. Report button 608 generates, or retrieves from memory, a report on the user that submitted the vacation request. This report can include any information the manager may find useful for approving a vacation request, such as hours worked, vacations previously taken, the group the employee works for, the evidence provided, and other information.

In some embodiments, table 602 may also include box 609 for each vacation request. Box 609 may include an approve/deny option for the vacation request, or it may provide an option to assign a reviewer to the vacation request for approval. The option to assign a review may be embodied as a drop-down menu, a series of buttons, a series of radio buttons, alphanumeric input, or other inputs known in the art.

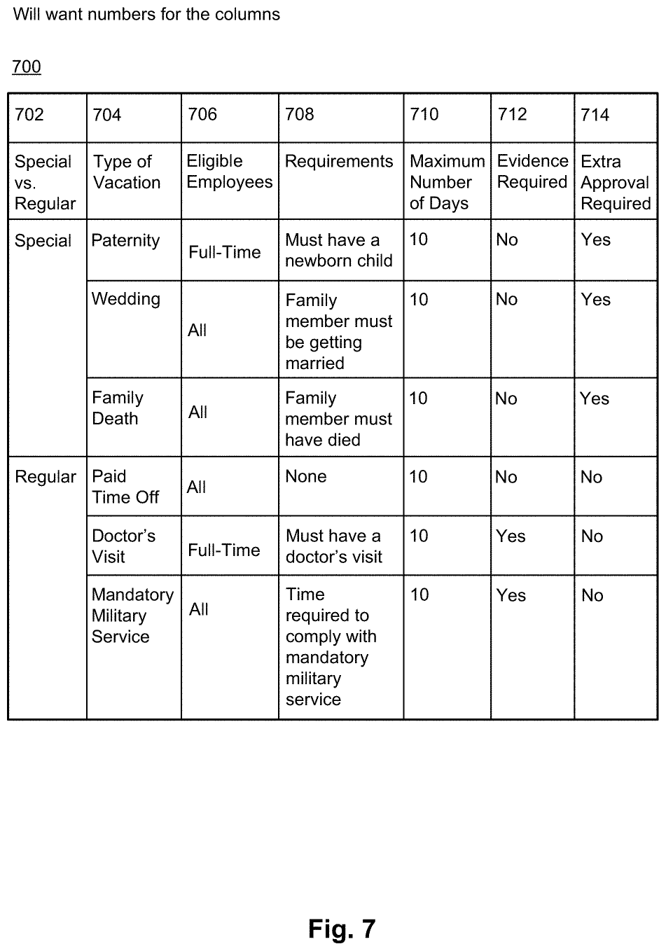

FIG. 7 illustrates an exemplary database table 700 of vacations that users can schedule. In some embodiments, the database table 700 may include columns such as vacation category column 702, vacation type column 704, employee eligibility column 706, requirements column 708, maximum number of days column 710, evidence requirement column 712, and extra approval requirement column 714. Database table 700 may include more or fewer columns depending on the employer's requirements for determining whether a user is eligible for a vacation and the requirements for approval.

In some embodiments, the types of vacations may be divided into categories, such as those in vacation category column 702, which includes special vacation and regular vacation categories. The types of vacations in vacation type column 704 can be sorted into these categories, as shown in FIG. 7. The special vacation category may signify events that do not happen frequently, such as paternity leave, weddings, and family deaths. The regular vacation category may signify types of vacation that occur on a regular basis, such as Paid Time Off (PTO), doctor's visits, or mandatory military service for countries that require citizens to perform certain military duties every year. In some embodiments, designating a vacation as a special vacation may obligate a user to meet an additional set of requirements beyond the typical requirements, such as requiring an additional manager to approve the vacation, requiring a specific person to approve, or any other requirement.

In some embodiments, employee eligibility column 706 can signify which employees can be eligible for a type of vacation. Employees may be divided into categories based on any criteria set by the employer, such as full-time employees, contractors, fulfillment center employees, warehouse employees, engineers, sales, managers, janitorial staff, or any other category. The table may then indicate which of the employee categories may be eligible for each type of vacation. For example, only full-time employees may qualify for paternity leave while all employees may qualify for PTO. In another embodiment, separate rows may be used for different employee categories to allow further changes in qualifications, such as the maximum number of days allowed for a type of vacation. For example, engineers may only have 10 days of PTO, but managers may have 15 days of PTO.

In some embodiments, the requirements column 708 may set any special requirements that may be necessary for a user to qualify for the type of vacation. For example, if a user is requesting to take paternity leave, requirement column 708 may dictate that the user must have a newborn child at home. As another example, if a user is requesting to take time for the mandatory military service, then the user must have received an official notice setting their assigned time for performing the military service.

In some embodiments, maximum number of days column 710 may set the maximum number of days that user may qualify for a type of vacation. In some embodiments, this number may vary for the same type of vacation depending on other columns, such as the employee eligibility column 706 as discussed herein.

In some embodiments, evidence requirement column 712 may dictate whether evidence is required to qualify for the type of vacation. For example, users may receive a notice that they must perform their mandatory military service, and the system may require the user to provide this notice as evidence. In some embodiments, evidence requirement column 712 may be a yes/no requirement, may specify qualifying evidence, or may set any other requirement desired by the employer.

In some embodiments, extra approval requirement column 714 may determine whether a type of vacation requires an additional manager to approve the vacation besides the default number of approvers. For example, special vacations may require two managers to approve the vacation whereas a regular vacation only requires one manager to approve. In some embodiments, the type of vacation may require the approval of a specific person. This may be indicated in extra approval requirement column 714, in another column shown, or in an additional column not shown.

Computing devices described in the written description to perform the methods described herein as known in the art, and an exemplary computing device 800 are shown in FIG. 8. The computing device may be a mobile device such as a mobile phone, a PDA, or a tablet. Further, the computing device may be a computer terminal accessing WMS 119 or LMS 125, a server, or any other type of computing device known in the art that accesses system 100. For example, computing device 800 may include one or more memory devices storing data and software instructions and one or more processors configured to use the data and execute the software instructions to perform operations including sending data and other operations known in the art. In some embodiments, computing device 800 may have an application installed thereon to perform one or more processes that are consistent with the disclosed embodiments. The components of computing device 800 may be implemented as specialized circuitry integrated within processor 802 or in communication with processor 802, and/or as specialized software stored in memory device 804 executable by processor 802.

Processor 802 may be implemented as one or more known or custom processing devices designed to perform functions of the disclosed methods, such as single- or multiple-core processors capable of executing parallel processes simultaneously to allow computing device 800 to execute multiple processes simultaneously. For example, processor 802 may be configured with virtual processing technologies. Processor 802 may implement virtual machine technologies, including a Java virtual machine, or other known technologies to provide the ability to execute, control, run, manipulate, store, etc., multiple software processes, applications, programs, etc. One of ordinary skill in the art would understand that other types of processor arrangements could be implemented that provide for the capabilities disclosed herein.

Memory device 804 may include instructions to enable processor 802 to execute programs, such as one or more operating systems, server applications, network communication processes, and any other type of application or software known to be available on computer systems. Alternatively or additionally, instructions may be stored in remote storage (not shown) in communication with computing device 800, such as one or more database or memory modules accessible over system 100. The internal database and external storage may be implemented in volatile or non-volatile, magnetic, semiconductor, tape, optical, removable, non-removable, or another type of storage device or tangible (i.e., non-transitory) computer-readable medium.

In some embodiments, memory device 804 includes instructions that, when executed by processor 802, perform one or more processes consistent with the functionalities disclosed herein. Methods, systems, and articles of manufacture consistent with the disclosed embodiments are not limited to separate programs or computers configured to perform dedicated tasks. For example, memory device 804 may include one or more programs, as described herein, for execution by processor 802 to perform one or more functions of the disclosed embodiments. Moreover, processor 802 may execute one or more programs located remotely from computing device 800. For example, computing device 800 may access one or more remote programs, that, when executed, perform functions related to disclosed embodiments.

I/O device 806 may comprise one or more interfaces for receiving input signals from other devices and for providing output signals to other devices to allow data to be received and/or transmitted by computing device 800. I/O device 806 may receive input signals from a screen (e.g., a touch screen or a stylus-activated screen), a network controller or device (e.g., wireless, wired, cellular, or satellite), or non-tactile inputs (e.g., keyboard or mouse). I/O device 806 may also include interface components that display information and/or provide interfaces to one or more input devices, such as one or more keyboards, mouse devices, and the like, to enable computing device 800 to receive input from a recipient (not shown). Processor 802 may utilize data from a network device in I/O device 806 (e.g., signal strength, IP address, or the like) to determine a location of computing device 800. For example, processor 802 may use triangulation, IP address geolocation, signal strength analysis or signal strength mapping, or the like.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

The programs may include, for example, an operating system. Programs may be implemented or integrated using one or more commercial and/or open sourced platforms, such as Chassis™, PostgreSQL™, Apache Kafka™, Open NLP™, Spark™, Amazon Web Services™, Docker™, Jenkins™, HTML™, CSS™, Less™, AngularJS™, etc.

Memory 804 may further include the programs in accordance with the disclosed embodiments. The programs may further include components that facilitate learning and data analysis by processor 802 such as one or more data processing module(s), machine learning module(s), artificial intelligence module(s), neural network module(s), analytic module(s), and/or other modules. Various components of these programs may be used in the disclosed embodiments. The programs may be constructed in a highly adaptive way, such as using, for example, representation state transfer technology.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented device for tracking a user's time, the device comprising:
a memory storing instructions;
a network device;
a display device; and
at least one processor configured to execute the instructions to:
at a first time, determine a first location of the computer-implemented device based on one or more network signals from the network device;
determine the first determined location is outside a predetermined area;
in response to determining that the first determined location is outside the predetermined area, display, on the display device, a first user interface element indicating that the element is unselectable based on a color of the first user interface element;
determine, at a second time, a second location of the computer-implemented device is within the predetermined area;
determine the computer-implemented device is accessed during a work schedule;
in response to determining that the second determined location is within the predetermined area and determining that the computer-implemented device is accessed during the work schedule, display, on the display device, a second user interface element that, when selected, records a start time associated with a user identifier;
receive, from the display device, a selection of the second user interface element;
after receiving a selection of the second user interface element, display, on the display device, a third user interface element that, when selected, records an end time associated with the user identifier;
send, via the network device, a query to the remote server to determine event data associated with the user identifier, the event data comprising an indication that a package identifier was scanned by a device associated with the user identifier;
receive, via the network device, the event data from the remote server; and
based on a selection of the third user interface element received from the display device or the event data received from the remote server, send the end time to the remote server via the network device.

2. The computer-implemented device of claim 1, wherein displaying the second user interface element is based on determining that the current time is within an accepted time.

3. The computer-implemented device of claim 2, wherein the accepted time is based on at least one of a vacation schedule, a shift schedule, or a needed capacity.

4. The computer-implemented device of claim 1 , wherein the instructions further cause the at least one processor to:
receive, from a remote server, an amount of time worked by the user during a first time frame;
determine whether the amount of time worked is greater than a maximum amount of time for the first time frame; and
based on the determination, prevent the display of the first user interface element.

5. The computer-implemented device of claim 4, wherein the instructions further cause the at least one processor to display a warning when the amount of time worked within the first time frame exceeds a threshold amount of time that is smaller than the maximum amount of time.

6. The computer-implemented device of claim 4 wherein the instructions further cause the at least one processor to display a warning when the amount of time worked within the first time frame exceeds the maximum amount of time within the first time frame.

7. The computer-implemented device of claim 4, wherein the instructions further cause the at least one processor to record the end time associated with the user identifier based on determining that the amount of time worked within the time frame exceeds the maximum amount of time within the time frame.

8. The computer-implemented device of claim 4, wherein the end time is determined by the remote server based on the event data.

9. The computer-implemented device of claim 6, wherein the instructions further cause the at least one processor to
responsive to the selection of the second user interface element, send a token to the remote server;
send, via the network device, a query to the remote server to determine whether the token has been used within a second time frame;
receive, via the network device, activity information from the remote server indicating whether the token has been used within the second time frame; and
based on the activity information, record the end time associated with the user identifier.

10. The computer-implemented device of claim 8, wherein the instructions further cause the at least one processor to send, via the network device, a query to the remote server when the number of hours worked within a time frame exceeds a threshold number of hours that is smaller than the maximum number of hours.

11. The computer-implemented device of claim 1, wherein the instructions further cause the at least one processor to record the end time associated with the user identifier based on a determination that the computer-implemented device is outside of an accepted location.

12. The computer-implemented device of claim 1, wherein the location is determined based on a proximity of a wireless network.

13. The computer-implemented device of claim 1, wherein the computer-implemented device sends the data collected to the central system based on scheduled updates or in real time.

14. The computer-implemented device of claim 1, wherein the second user interface element includes an input field for information regarding the user's job during the logged in time.

15. The computer-implemented device of claim 1, wherein the instructions further cause the at least one processor to:
display, on the display device, at least one category of job role;
receive, on the display device, an input selecting at least one of the categories of job roles;
display, on the display device, at least one question based on the category of job role selected; and
receive, on the display device, at least one answer to the at least one question.

16. A method for tracking a user's time, comprising the steps of:
determining, at a first time, a first location of a computer-implemented device based on one or more network signals from a network device of the computer-implemented device;
determining the first determined location is outside a predetermined area;
in response to determining that the first determined location is outside the predetermined area, displaying, on the display device, a first user interface element indicating that the element is unselectable based on a color of the first user interface element;
determining, at a second time, a second location of the computer-implemented device is within the predetermined area;
determining the computer-implemented device is accessed during a work schedule;
in response to determining that the second determined location is within the predetermined area and determining that the computer-implemented device is accessed during the work schedule, displaying on a display device of the computer-implemented device, a second user interface element that, when selected, records a start time associated with a user identifier in a memory device of the computer implemented device;
receiving, from the display device, a selection of the second user interface element;
displaying, after receiving a selection of the second user interface element on the display device, a third user interface element that, when selected, records an end time associated with a user identifier in the memory device of the computer implemented device;
send, via the network device, a query to the remote server to determine event data associated with the user identifier, the event data comprising an indication that a package identifier was scanned by a device associated with the user identifier;
receive, via the network device, the event data from the remote server; and
based on a selection of the third user interface element received from the display device or the event data received from the remote server, send the end time to the remote server via the network device.

17. The method of claim 16, wherein displaying the first user interface element is based on determining that the current time is within an accepted time.

18. The method of claim 16, further comprising the steps of:
receiving, from a remote server, an amount of time worked by the user during a first time frame;
determining whether the amount of time worked is greater than a maximum amount of time for the first time frame; and
based on the determination, preventing the display of the first user interface element.

19. The method of claim 18 further comprising the step of displaying a warning when the amount of time worked within the first time frame exceeds the maximum amount of time within the first time frame.

20. A system for tracking a user's time comprising a mobile device and a central server:
the mobile device comprising:
a network device;
a display device;
at least one processor and at least one memory storing instructions, the at least one processor configured to execute instructions to:
at a first time, determine a first location of the mobile device based on one or more network signals from the network device;
determine the first determined location is outside a predetermined area;
in response to determining that the first determined location is outside the predetermined area, display, on the display device, a first user interface element indicating that the element is unselectable based on a color of the first user interface element;
determine, at a second time, a second location of the mobile device is within the predetermined area;
determine the mobile device is accessed during a work schedule;
in response to determining that the second determined location is within the predetermined area and determining that the mobile device is accessed during the work schedule, display, on the display device, a second user interface element that, when selected on the display device, records a time associated with a start time for a user;
receive, from the display device, a selection of the second user interface element;
send data contained within the start input to a central server after receiving the input selecting the first user interface element;
receive analytical data from the central server about the user;
after receiving a selection of the second user interface element, display on the display device, a third user interface element that, when selected on the display device, records a time associated with an end time for the user;
send, via the network device, a query to the central server to determine event data associated with the user identifier, the event data comprising an indication that a package identifier was scanned by a device associated with the user identifier:
receive, via the network device, the event data from the remote server; and
based on a selection of the third user interface element received from the display device or the event data received from the central server, send the end time to the central server via the network device:
the central server comprising:
a network device;
a database; and
at least one processor and at least one memory storing instructions, the at least one processor configured to execute instructions to:
receive, via the network device, time data including at least one of a start time or an end time;
store the received time data in the database in association with a user identifier;
receive a request from the mobile device for event data associated with the user identifier, the event data comprising an indication that a package identifier was scanned by a device associated with the user identifier; and
send event data to the mobile device.
